(19) United States
(12) Patent Application Publication
(10) Pub. No.: US 2009/0229398 A1
(43) Pub. Date: Sep. 17, 2009

(54) Electromechanical motion hand

(76) Inventor: Franklin Leon Vargas, Eden, TX (US)

Correspondence Address: FRANKLIN L. VARGAS, CCA/EDEN DETENTION CENTER, EDEN, TX, 76837, US

(21) Appl. No.: 12/383,249

(22) Filed: Mar. 23, 2009

Related U.S. Application Data
(60) Provisional application No. 61/070,417, filed on Mar. 24, 2008.

(51) Int. Cl. B25J 17/02; G05B 15/00

(52) U.S. Cl. 74/490.06; 700/264; 901/2

(57) ABSTRACT

EMH presents an unique gear-pulley arrangaments controlled by two individuals DC. Motors, and two remote control units (RCU). A single input from a foot pad, does start the grabbing motion. A mechanical sensor decodes the pressure applied for the fingers upon the objects and cut the power supply from the motor.

The electronic circuit is designed to control the grabbing motion, close/open in alternating cicle.

Wrist motion is controlled by a second RCU installed back, between the shoulder blades of the patient. A right side RCU's continue input, does start wrist motion to the left direction until required/max. 180°. Releasing input, stop wrist motion.

A left side RCU's input, does start wrist motion in opposite direction.

EMH is of easy assembling, wireless and of simple design. Many components were minimized to improve maintenance and reduce costs. EMH is aimed to help limb people in poor countries.

### CROSS-REFERENCE:

U.S.61/070,417, 03/24/2008 filing date. Provisional.

### BACKGROUND OF THE INVENTION

This invention pertains to the Human Prosthetics field and was designed twenty (20) years ago in Colombia when the present claimant met a man who had both of his hands amputed. In those days this claimant had not seen any human being using an electrical prothesis, but prosthetic curved hooks which had to be moved by using the back muscles of the patient. Thinking in those impediments and the harmly effort of those limb people, this claimant engaged in a race to match the design, developing and magnufacturing of his electromechanical motion hand (hereinafter, EMH).

### BRIEF SUMMARY OF THE INVENTION

The EMH will allow an arm's limb patient a “second Chance” to grab and release objects againg by assembling it to the remaining of his/her limb arm. Two remote control unit (RCU), one installed as a foot pad as illustrated in FIGS. 1C and 1D, will control the grabbing and release motion. A second RCU installed in the back of the patient between the shoulder blades will cont- rol the wrist motion. FIGS. 6-6A This EMH is wireless, an innovation that improve the assembling and the use of it for persons without technical skills.

### BRIEF DESCRIPTION OF THE SEVERAL VIEWS OF THE DRAWING

The preferred embodiment 10 is an electromechanical motion hand 10 which simulates the mechanical function of a hand and comprising:

The frame 11 secured a group of pivotable members 13a, 13b, 13c, 13d and 13e, which simulates the shape, position and mechanical function of each fingers. Connected to the frame 11 there is a flat portion 12 which extends downward, it includes a battery pack 14 electrically connected to a momentary normally open switch 15, to electromechanical actuator 50, to a rotating-altern device 16 (commutator), and to a limit switch 30. All of them are the electrical path which allows for performing of the actuator 50 to perform in a direction to drive the main belt 17. The next input does the actuator to perform on opposite direction; thus the preferred embodiment 10 close or open the group of pivotable members 13a-13e by activate the switch 15, which presently have been illustrated in an user's foot 21 FIGS. 1A-1D.

FIG. 2 shows a perspective view of the preferred embodiment 10 coming from FIG. 1 in a rest position, the cover to simulates the skin is not illustrated, however, it illustrates a partial assembly of a single pivotable member 13a where the driver's belt is not illustrated.

The pivotable members 13b, 13c, 13d and 13e illustrates a fully assembly. Each fully assembly illustrates a belt 25b 25c, 25d and 25e connected to the end section of each pivotable member.

The member 13e do not show the belt but show a spring means 27e.

The rest of the members 13a-13d also has a spring means, but is not showed in the drawing figures. The function of the spring means is to mantain open the pivotable members when the belts 25a-25e release the pressure. A belt connected to the pivotable member 25e is illustrated in FIG. 3. The force applicated by the belts 25a-25e is large than the force produced by spring means 25a-25e.

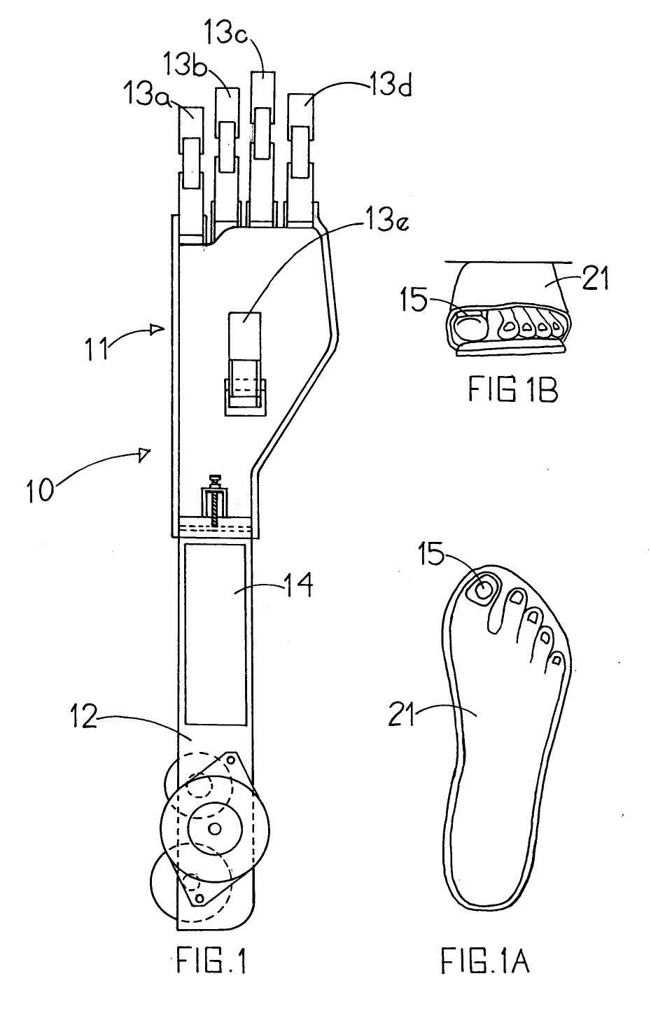

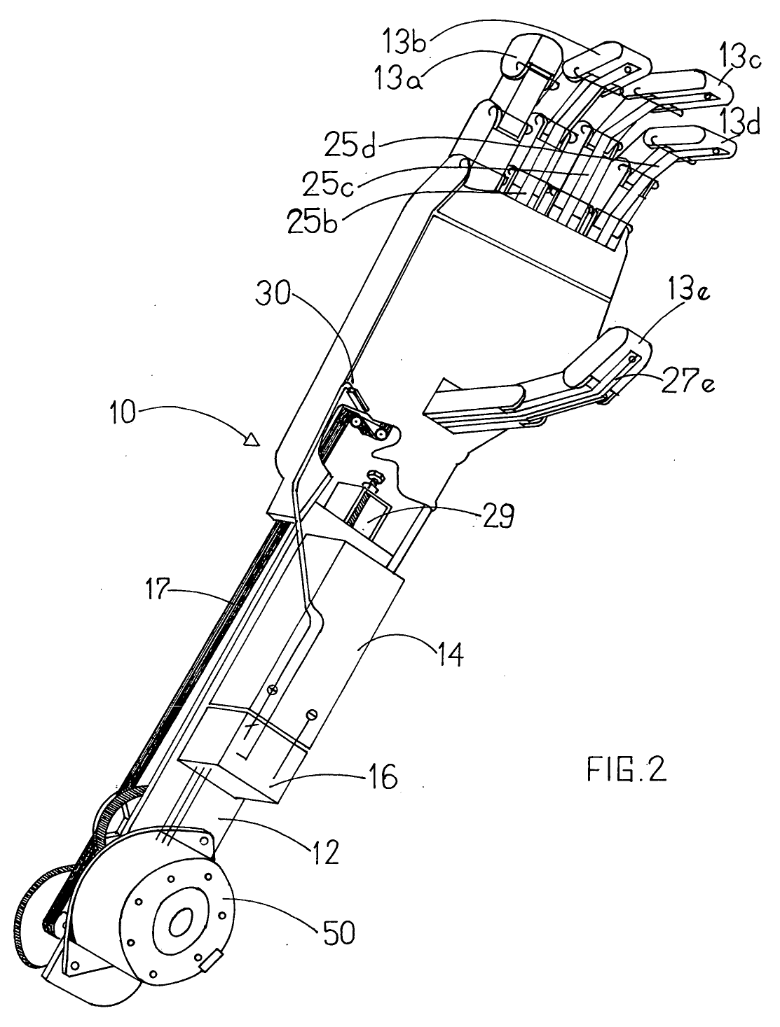

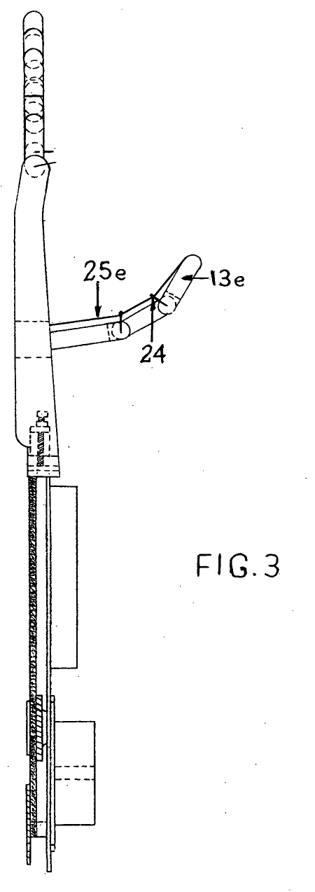

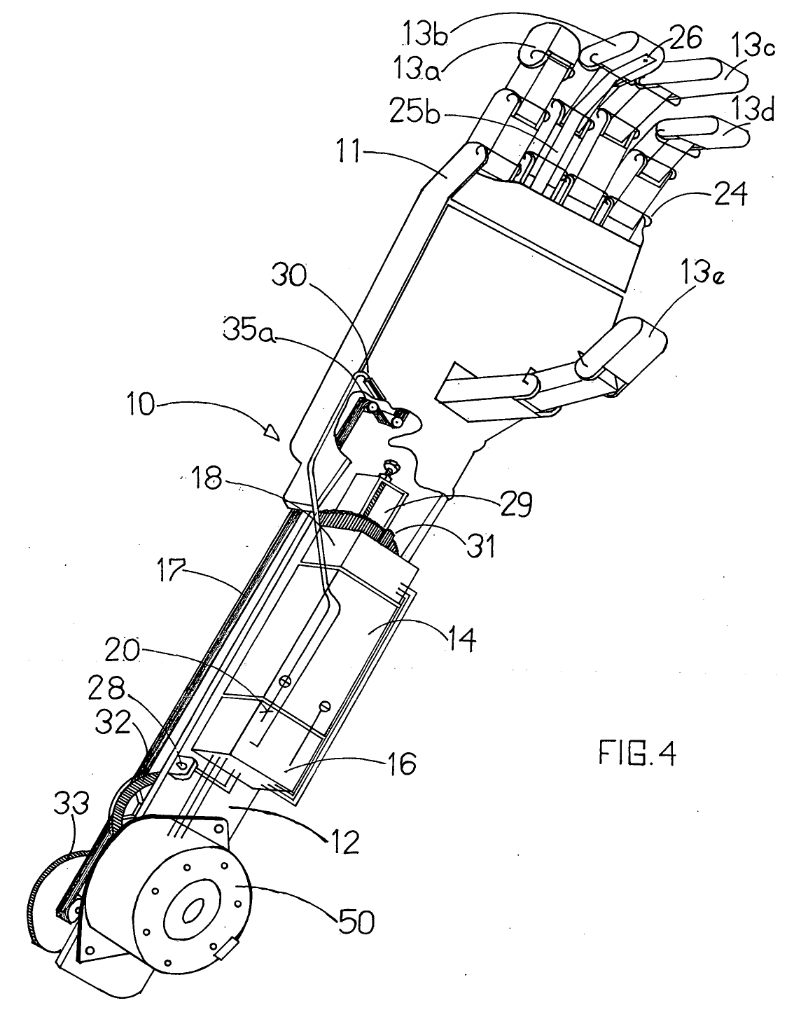

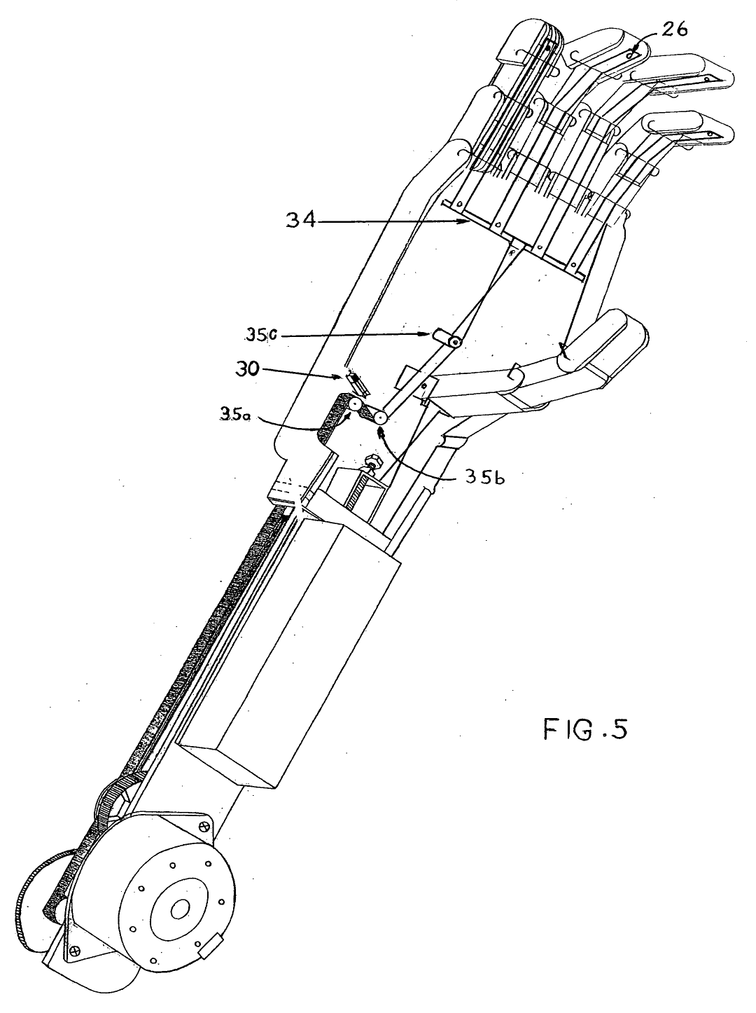

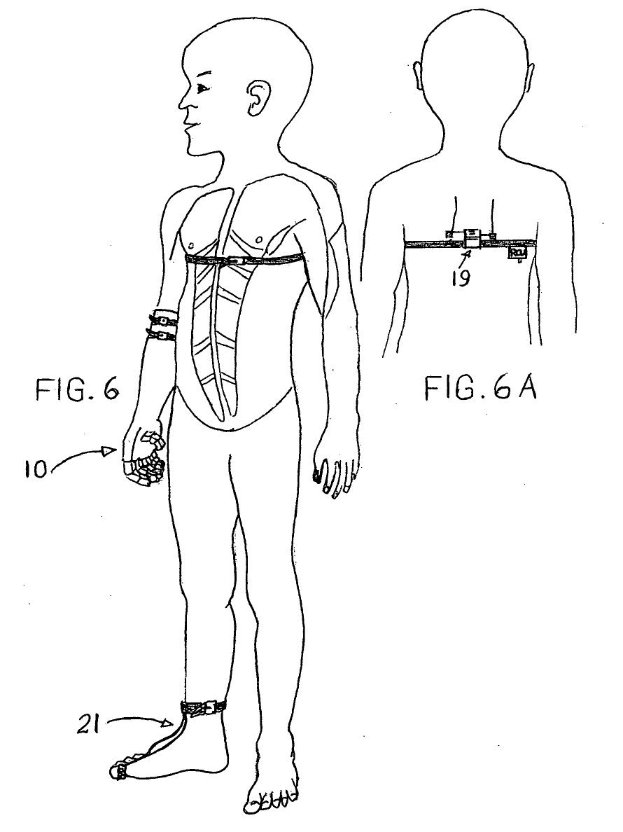

A pressure belt sensor 29 FIG. 2 controls and adjust the pressure on the main belt 17.

A switch connected to a second belt sensor 30 have been used to automatically disconnect the power from the actuator 50.

A manual adjustment could be completed by adjust the belt tensioner 29.

Thereby the preferred embodiment 10 could be used to help people having amputed hands to simulate mechanically the function of his/her hands, to grab and release light objects and to be utilized as a transition to help those in adapting for the use of advanced prothesis.

### DETAILED DESCRIPTION OF THE INVENTION

This EMH as its title so describe it, is an electrome-chanical device which is compossed of many parts and joint together will simulate mechanically the function of a human hand and in this case, will allow a limb patient remain active despite of that impediment. The EMH parts as described in FIGS. 1-6 as follows:
10, is the preferred embodiment
11, is the frame of the EMH
12, is the flat portion of the EMH
13a-13e, are the pivotable members (fingers)
14, is a 12V. DC. Battery
15, is the food pad switch (RCU)
16, is an electronic circuit (rotating alterning device)
17, is the main belt system
18, is a motor or actuator (wrist motion)
19, is the wrist motion switch (RCU)
20, is an on/oof switch
21, is a foot pad (RCU)
22, is an IR emisor LED (infrared)
25a-25d, is the nylon tendons
261-26d, is the tendon fasteners
27e, is a spring means
28, is an IR receptor LED
29, is a pressure belt sensor
30, is a limit switch
31, is the wrist gear
32, is the main belt gear
33, is a secondary gear
34, is the tendon joint bars
35a-35c, is the tendon pulleys
50, is the main belt motor or actuator

The preferred embodiment 10, and the pivotable members 13a-13e will be constructed of reinforced plastics/composites with mechanical properties which significantly will improve its functions. This EMH will be essentially constructed in fiber-reinforced thermoplastic materials and will be typically processed under standard thermoplastic processing equipment.

For a full assembly of the EMH mechanical parts, any manufacturer could tracing the following steps:

Once the preferred embodiment 10 and the pivotable members 13a-13e has been thermoplastically constructed, they shall be drilled out to then be secured as showed in FIG. 1.

The joints which conform the pivotable members shall be assembled between it by securing them using the formed steel pin 24 there depicted. Each pivotable member is compossed of three parts (as the fingers in the human being), and once joined they shall be fitted in the EMH's frame 11 by securing them to it using the same formed steel pin 24 used for the joints. (Pin 24, was standarized to reduce cost and easying the magnufacturing processing).

Once the pivotable members has been fitted in the EMH frames, then the nylon tendons shall be secured to the extreme or end section of each pivotable member by using a screw 26.

Each tendon shall be passed individually through the space betweeen the pivotable member and each pin. FIG. 3.

The pins 24 performs double function: one, is to secure the joints between itself and to the frame; and two, it does as basis for each tendon can sustent the pulling pressure to contract or close the pivotable members 13a-13e. FIG. 3.

After the tendons has been secured to the pivotable members, then they shall be fastened to the alluminium bar 34. See, FIG. 5.

A main tendon shall be fastened in the center of the bar, and then it shall be passed between two parallel pulleys 35a, 35b mounted in a balancing and finally, it shall be secured to the main belt system 17. FIG. 5.

A pressure rendered upon the balancing pulleys is the result of the pulling effect of the main belt upon the nylon tendons when the EMH is in grabbing motion. An object grabbed by the EMH makes the main tendon performing a pushing pressure upon the balancing pulleys forcing it to push a micro single pole switch 30 which cuts the power supply from the motor 50. It cause the EMH grabbing motion be stopped. FIG. 4.

The main belt is driven for a motor or actuator 50 which is engaged to it through a gear 32. Motor 50 also drives a secondary gear 33 which controls the single pivotable member 13e. FIG. 4.

For a full attaching of the EMH to a limb arm is preferable follows the steps described below:

The preferred embodiment 10, shall be fitted in the limb arm by encapsuling the limb in the end case of the EMH. There will be also a couple of leather belts which will keep the EMH properly secured. FIG. 6-6A.

A wrist motion remote control unit shall be fitted in the back of the patient, between the shoulder blades which after a light movement of the side wished does start the wrist motion. e.g.,

A right movement does start the wrist motion to the left side, and viceverse. FIG. 6-6A.

A foot pad remote control unit shall be fitted in a foot of the patient. Then, after a single input of it, the EMH does start the grabbing motion. A second input will release the pressure of the fingers. FIG. 1C-1D.

1. The Wrist Motion System

2. The Shoulder Blades Remote Control Unit

3. The Main Belt System

4. The Electronic Alternating Cicle System

5. The Foot Pad Remote Control Unit

6. The Mechanical Pessure Control System
